(19) United States
(12) Patent Application Publication
(10) Pub. No.: US 2020/0151558 A1
(43) Pub. Date: May 14, 2020

(54) SYSTEMS AND METHODS FOR UPDATING AN ARTIFICIAL INTELLIGENCE MODEL BY A SUBSET OF PARAMETERS IN A COMMUNICATION SYSTEM

(71) Applicant: Gyrfalcon Technology Inc., Milpitas, CA (US)

(72) Inventors: Yongxiong Ren, San Jose, CA (US); Yequn Zhang, San Jose, CA (US); Baohua Sun, Fremont, CA (US); Xiaochun Li, San Ramon, CA (US); Qi Dong, San Jose, CA (US); Lin Yang, Milpitas, CA (US)

(73) Assignee: Gyrfalcon Technology Inc., Milpitas, CA (US)

(21) Appl. No.: 16/272,958

(22) Filed: Feb. 11, 2019

Related U.S. Application Data
(63) Continuation-in-part of application No. 16/189,903, filed on Nov. 13, 2018.
Application No. 16/189,903 is a continuation-in-part of application No. 16/189,936, filed on Nov. 13, 2018.

(51) Int. Cl. G06N 3/08; G06N 20/00

(52) U.S. Cl. CPC G06N 3/08; G06N 20/00

(57) ABSTRACT

A system may be configured to obtain a global artificial intelligence (AI) model for uploading into an AI chip to perform AI tasks. The system may implement a training process including receiving updated AI models from one or more client devices, determining a global AI model based on the received AI models from the client devices, and updating initial AI models for the client devices. Each client device may receive an initial AI model and train an updated AI model by training the entire parameters of the AI model together, by training a subset of the parameters of the AI model in a layer by layer fashion, or by training a subset of the parameters by parameter types. Each client device may include one or more AI chips configured to run an AI task to measure performance of an AI model. The AI model may include a convolutional neural network.

### CROSS-REFERENCE TO RELATED APPLICATION

This application is a continuation-in-part of U.S. patent application Ser. No. 16/189,903 filed Nov. 13, 2018 and U.S. patent application Ser. No. 16/189,936 filed Nov. 13, 2018. These applications are incorporated by reference herein in their entirety and for all purposes.

### FIELD

This patent document relates generally to systems and methods for providing artificial intelligence solutions. Examples of determining an artificial intelligence model for loading into an artificial intelligence chip in a communication system are provided.

### BACKGROUND

Artificial intelligence solutions are emerging with the advancement of computing platforms and integrated circuit solutions. For example, an artificial intelligence (AI) integrated circuit (IC) may include a processor capable of performing AI tasks in embedded hardware. Hardware-based solutions, as well as software solutions, still encounter the challenges of obtaining an optimal AI model, such as a convolutional neural network (CNN). A CNN may include multiple convolutional layers, and a convolutional layer may include multiple weights, bias and other parameters. Given the increasing size of the CNN that can be embedded in an IC, a CNN may include hundreds of layers and may include tens of thousands of weights. For example, the weights for an embedded CNN inside an AI chip may take as large as a few megabytes of data. This makes it difficult to obtain an optimal CNN model because a large amount of computing time is needed.

### BRIEF DESCRIPTION OF THE DRAWINGS

The present solution will be described with reference to the following figures, in which like numerals represent like items throughout the figures.

FIG. 1 illustrates an example system in accordance with various examples described herein.

FIG. 2 illustrates a diagram of an example process of obtaining a global AI model in accordance with various examples described herein.

FIG. 3 illustrates a diagram of an example process of obtaining a local AI model that is implemented in a processing device in accordance with various examples described herein.

FIG. 4 illustrates a variation of the example process in FIG. 2 in accordance with various examples described herein.

FIGS. 5-6 illustrate diagrams of example processes of obtaining a local AI model that may be implemented in a processing device in accordance with various examples described herein.

FIG. 7 illustrates various embodiments of one or more electronic devices for implementing the various methods and processes described herein.

### DETAILED DESCRIPTION

As used in this document, the singular forms “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Unless defined otherwise, all technical and scientific terms used in this document have the same meanings as commonly understood by one of ordinary skill in the art.

Each of the terms “artificial intelligence logic circuit” and “AI logic circuit” refers to a logic circuit that is configured to execute certain AI functions such as a neural network in AI or machine learning tasks. An AI logic circuit can be a processor. An AI logic circuit can also be a logic circuit that is controlled by an external processor and executes certain AI functions.

Each of the terms “integrated circuit,” “semiconductor chip,” “chip,” and “semiconductor device” refers to an integrated circuit (IC) that contains electronic circuits on semiconductor materials, such as silicon, for performing certain functions. For example, an integrated circuit can be a microprocessor, a memory, a programmable array logic (PAL) device, an application-specific integrated circuit (ASIC), or others. An integrated circuit that contains an AI logic circuit is referred to as an AI integrated circuit.

The term “AI chip” refers to a hardware- or software-based device that is capable of performing functions of an AI logic circuit. An AI chip can be a physical IC. For example, a physical AI chip may include an embedded cellular neural network (CeNN), which may contain weights, bias and/or parameters ofa CNN. The AI chip may also be a virtual chip, i.e., software-based. For example, a virtual AI chip may include one or more processor simulators to implement functions of a desired AI logic circuit of a physical AI chip.

The term of “AI model” refers to data that include one or more parameters that are used for, when loaded inside an AI chip, executing the AI chip. For example, an AI model for a given CNN may include the weights, bias and other parameters for one or more convolutional layers of the CNN. Here, the weights and parameters of an AI model are interchangeable.

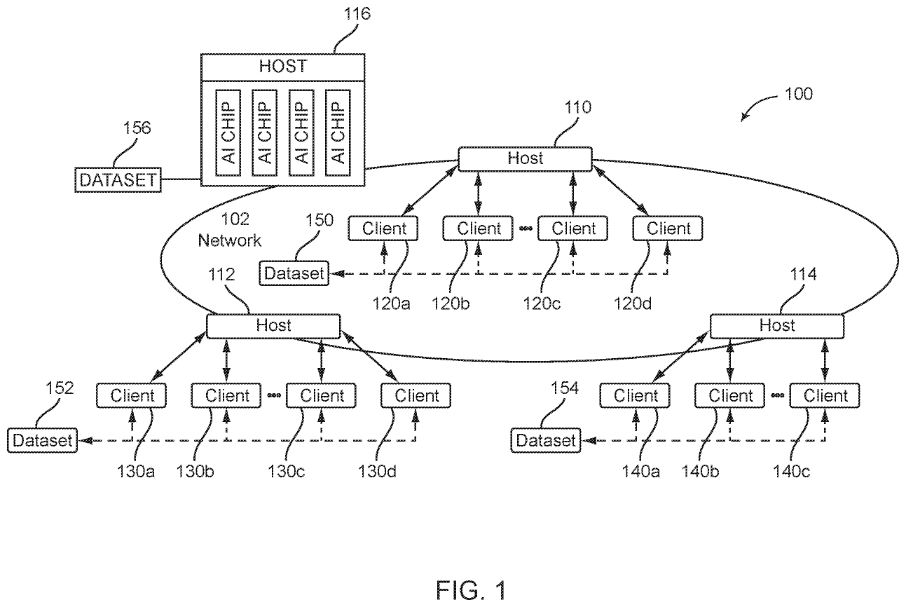

FIG. 1 illustrates an example system in accordance with various examples described herein. In some examples, a communication system 100 includes a communication network 102. Communication network 102 may include any suitable communication links, such as wired (e.g., serial, parallel, optical, or Ethernet connections) or wireless (e.g., Wi-Fi, Bluetooth, or mesh network connections), or any suitable communication protocols now or later developed. In some scenarios, system 100 may include one or more host devices, e.g., 110, 112, 114, 116. A host device may communicate with another host device or other devices on the network 102. A host device may also communicate with one or more client devices via the communication network 102. For example, host device 110 may communicate with client devices 120a, 120b, 120c, 102d, etc. Host device 112 may communicate with a client device, e.g., 130a, 130b, 130c, 130d, etc. Host device 114 may communicate with a client device, e.g., 140a, 140b, 140c, etc. A host device, or any client device that communicates with the host device, may have access to one or more datasets used for obtaining an AI model. For example, host device 110 or a client device such as 120a, 120b, 120c, or 120d may have access to dataset 150.

In FIG. 1, a client device may include a processing device. A client device may also include one or more AI chips. In some examples, a client device may be an AI chip. The AI chip may be a physical AI IC. The AI chip may also be software-based, i.e., a virtual AI chip that includes one or more process simulators to simulate the operations of a physical AI IC. A processing device may include an AI IC and contain programming instructions that will cause the AI IC to be executed in the processing device. Alternatively, and/or additionally, a processing device may also include a virtual AI chip, and the processing device may contain programming instructions configured to control the virtual AI chip so that the virtual AI chip may perform certain AI functions. In FIG. 1, each client device, e.g., 120a, 120b, 120c, 120d may be in electrical communication with other client devices on the same host device, e.g., 110, or client devices on other host devices.

In some examples, the communication system 100 may be a centralized system. System 100 may also be a distributed or decentralized system, such as a peer-to-peer (P2P) system. For example, a host device, e.g., 110, 112, 114, and 116, may be a node in a P2P system. In a non-limiting example, a client devices, e.g., 120a, 120b, 120c, and 120d may include a processor and an AI physical chip. In another non-limiting example, multiple AI chips may be installed in a host device. For example, host device 116 may have multiple AI chips installed on one or more PCI boards in the host device or in a USB cradle that may communicate with the host device. Host device 116 may have access to dataset 156 and may communicate with one or more AI chips via PCI board(s), internal data buses, or other communication protocols such as universal serial bus (USB).

In some scenarios, the AI chip may contain an AI model for performing certain AI tasks. In some examples, an AI model may include a forward propagation neural network, in which information may flow from the input layer to one or more hidden layers of the network to the output layer. For example, an AI model may include a convolutional neural network (CNN) that is trained to perform voice or image recognition tasks. A CNN may include multiple convolutional layers, each of which may include multiple parameters. For example, an AI model may include weights, bias and/or other parameters of the CNN model. In some examples, the weights of a CNN model may include a mask (kernel) and a scalar for a given layer of the CNN model. For example, a kernel in a CNN layer may be represented by multiple values in lower precision, whereas a scalar may be in higher precision. The weights of a CNN layer may include the multiple values in the kernel multiplied by the scalar. In some examples, an output channel of a CNN layer may include one or more bias values that, when added to the output of the output channel, adjust the output values to a desired range.

In a non-limiting example, in a CNN model, a computation in a given layer in the CNN may be expressed by Y=w*X+b, where X is input data, Y is output data in the given layer, w is a kernel, and b is a bias. Operation “*” is a convolution. Kernel w may include binary values. For example, a kernel may include 9 cells in a 3×3 mask, where each cell may have a binary value, such as “1” and “−1.” In such case, a kernel may be expressed by multiple binary values in the 3×3 mask multiplied by a scalar. The scalar may include a value having a bit width, such as 12-bit or 16-bit. Other bit length may also be possible. By multiplying each binary value in the 3×3 mask with the scalar, a kernel may contain values of higher bit-length. Alternatively, and/or additionally, a kernel may contain data with n-value, such as 7-value. The bias b may contain a value having multiple bits, such as 12 bits. Other bit length may also be possible.

In the case of physical AI chip, the AI chip may include an embedded cellular neural network that has memory containing the multiple weights, bias and/or parameters in the CNN. In some scenarios, the memory in a physical AI chip may be a one-time-programmable (OTP) memory that allows a user to load a CNN model into the physical AI chip once. Alternatively, a physical AI chip may have a random access memory (RAM) or other types of memory that allows a user to update and load a CNN model into the physical AI chip multiple times.

In the case of virtual AI chip, the AI chip may include a data structure that simulates the cellular neural network in a physical AI chip. A virtual AI chip can be of particular advantageous when multiple tests need to be run over various CNNs in order to determine a model that produces the best performance (e.g., highest recognition rate or lowest error rate). In a test run, the weights, bias and other parameters in the CNN can vary and be loaded into the virtual AI chip without the cost associated with a physical AI chip. Only after the CNN model is determined will the CNN model be loaded into a physical AI chip for real-time applications. Training a CNN model may require significant amount of computing power, even with a physical AI chip, because a CNN model may include tens of thousands of weights. For example, a modern physical AI chip may be capable of storing a few megabytes of weights inside the chip.

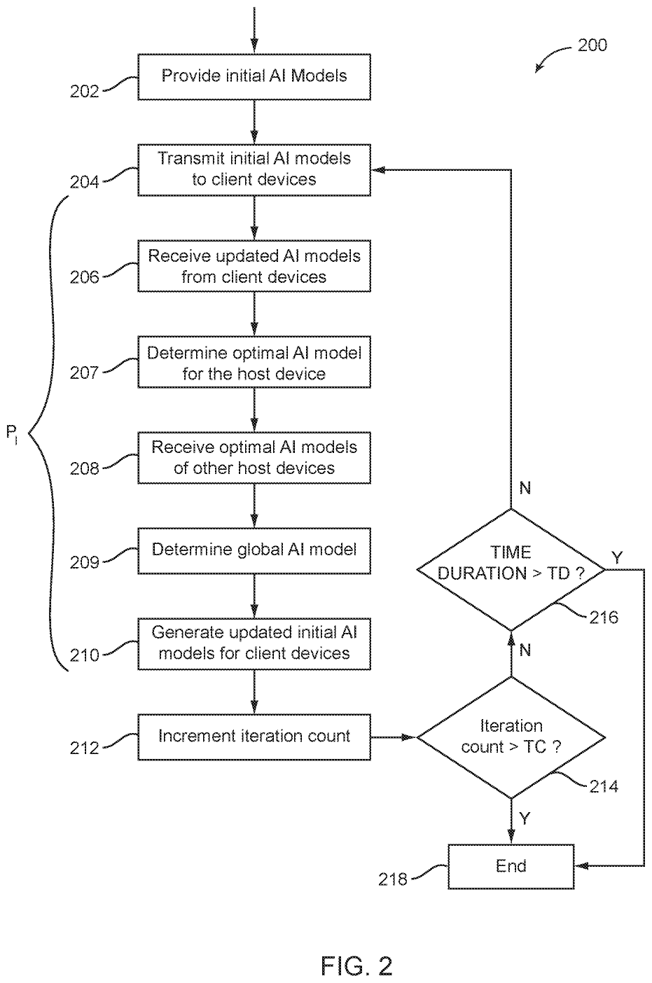

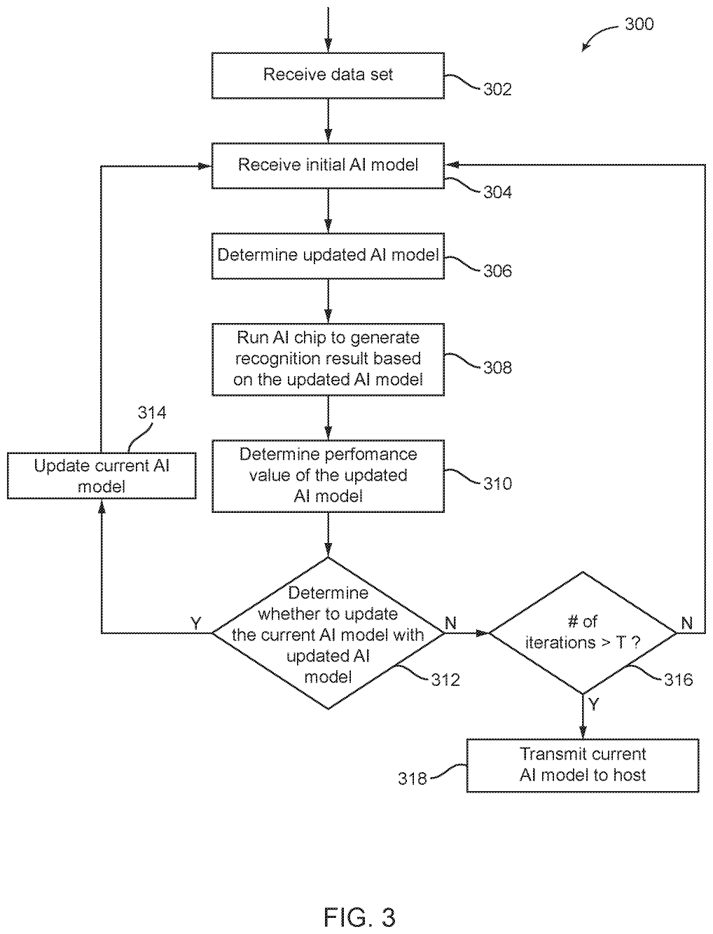

With further reference to FIG. 1, a host device on a communication network as shown in FIG. 1 (e.g., 110) may include a processing device and contain programming instructions that, when executed, will cause the processing device to access a dataset, e.g., 150, for example, test data. The test data may be provided for use in obtaining the AI model. In doing so, the AI model may be trained depending on the test data. For example, test data may be used for training an AI model that is suitable for face recognition tasks, and may contain any suitable dataset collected for performing face recognition tasks. In another example, test data may be used for training an AI model suitable for scene recognition in video and images, and may contain any suitable scene dataset collected for performing scene recognition tasks. In some scenarios, test data may reside in a memory in a host device. In one or more other scenarios, test data may reside in a central data repository and is available for access by any of the host devices (e.g., 110, 112, 114 in FIG. 1) or any of the client devices (e.g., 120a-d, 130a-d, 140a-d in FIG. 1) via the communication network 102. In some examples, system 100 may include multiple test sets, such as datasets 150, 152, 154. A CNN model may be obtained by using the multiple devices in a communication system such as shown in FIG. 1. Details are further described with reference to FIGS. 2-3.

Once a CNN model is obtained, it may be loaded into the AI chip for execution. For example, a CNN mode that is trained for face recognition tasks may be loaded into respective parameters (including weights) of the AI chip. A host or client device may cause the AI chip to perform various AI tasks using the trained weights and parameters. For example, a client device may feed an input image into the AI chip and receive a recognition result from the AI chip. The recognition result may indicate which class the input belongs to. In a non-limiting example, the CNN model may be capable of recognizing one or more classes from an input image, such as a cry and a smile face. In an example application, an AI chip may be installed in a camera and store weights and parameters of the CNN model. The AI chip may be configured to receive a captured image from the camera, perform an image recognition task based on the captured image and stored the CNN model, and output the recognition result. The camera may display, via a user interface, the recognition result. For example, the CNN model may be trained for face recognition. A captured image may include one or more facial images associated with one or more persons. The recognition result may include the names associated with each input facial image. The user interface may display a person's name next to or overlaid on each of the input facial image associated with the person.

FIG. 2 illustrates a diagram of an example process for obtaining a global optimal AI model in accordance with various examples described herein. In some examples, a host device (such as 110 in FIG. 1) may be configured to program one or more client devices or one or more AI chips to which the host device is communicating (e.g., 120a, 120b, 120c, 120d under host device 110, or one or more AI chips under host device 116) to cause the multiple client devices or AI chips to determine an AI model for that host device. For example, a process 200, which may be implemented in a host device (e.g., 110, 112, 114 in FIG. 1), may include providing initial AI models at 202 for the client devices under the host device. Process 200 may also include transmitting the initial AI models at 204 to the client devices and/or AI chips. In some examples, the initial AI models may include multiple initial AI models, each for a respective client device or an AI chip (under the host device). The initial AI models may be identical, or different among different client devices or AI chips. Once a client device or an AI chip receives a respective initial AI model, that client device or AI chip may execute an AI task using the initial AI model to generate a respective updated AI model, which process may further be described in FIG. 3.

With further reference to FIG. 2, process 200 may include receiving updated AI models at 206 from the one or more client devices (or AI chips). In some examples, a client device may return a client device updated AI model to the host device. The host device subsequently receives multiple AI models, each from a client device. Process 200 may subsequently determine the optimal AI model for the host device at 207 based on the updated AI models of one or more client devices and a performance value associated with each AI model. Process 200 may repeat for a number iterations until the iteration count has exceeded a threshold T_{C} at 214 and/or the time duration of the process has exceeded a threshold T_{D} at 216. At each iteration, process 200 continues receiving updated AI models from the client devices at 206 and determining the optimal AI model for the host device at 207. For example, M″_{i,0}, M″_{i,1}, . . . , M″_{i,N-1} represent the updated AI model from each client device 0, 1, 2, . . . N−1, respectively, at ith iteration, where N represents the number of client devices under the host device. Let A″_{i,0}, A″_{i,1}, . . . , A″_{i,N-1} stand for the performance value of the updated AI model from each client device at the ith iteration.

In some examples, a model M may include one or more parameters of the CNN model, including weights (e.g., the scalar and the masks), bias values and other parameters. Model M may have any suitable data structure. For example, model M may include a flat one-dimensional (1D) structure that holds the CNN parameters and weights sequentially from a few bytes to a few megabytes or more. The parameters may depend on the CNN model, the AI task for which the AI model is to be obtained, and the dataset for performing the AI task using the AI chip. For example, an AI task having different complexity levels may require different sets of CNN parameters.

In some examples, a performance value A may include a single value measured as the recognition accuracy associated with an AI model M, such as the updated AI model from a client device. For example, A″_{i,0} may stand for the performance of model M″_{i,0} and have a value of 0.5. If H_{i,j} stands for the optimal AI model for the host device j at ith iteration, where j=0, 1, . . . , K−1, with K being the number of hosts in the network, then H_{i,j} may be determined as H_{i,j}=E(M″_{i,0}, M″_{i,1}, . . . , M″_{i,N-1}, A″_{i,0}, A″_{i,1}, . . . , A″_{i,N-1}). In other words, at each iteration, the optimal AI model for a host may be determined based on the received updated AI models and associated performance values from one or more client devices under that host. In a non-limiting example, a host device may determine the optimal AI model for that host device by selecting a received updated AI model that has the best performance value among all client devices under that host. For example, if the performance value represents the accuracy of recognition using an AI model, then selecting the best performance includes selecting an AI model that has the highest performance value among all client devices under the host device.

Although it is illustrated that, at each iteration, the optimal AI model for a host may be determined based on the received AI models and associated performance values from one or more client devices under that host, other variations may be possible. For example, the optimal AI model may be determined based on criteria other than the best performance value. In some examples, the optimal AI model for a host device may be determined based on the performance value of a subset of the client devices under that host device. For example, the process may select among top five of a total of ten client devices, or remove the bottom two client devices, in terms of performance value of the AI model associated with each client device.

Returning to FIG. 2, process 200 may further determine a global AI model at 209 based on the received AI models from the client devices. At each repeat (iteration), process 200 continues to update the global AI model at 209 and increments the iteration count at 212. If the iteration count has exceeded the threshold T_{C} at 214 and/or the time duration has exceeded the threshold T_{D} at 216, the process ends at 218. In some scenarios, when the process ends, the global optimal AI model is obtained as the final global AI model in process 200. In some examples, the process may output the final global AI model, as the global optimal AI model, to the one or more hosts on the network. Upon receiving the final global AI model, a host device may load the global optimal AI model into one or more client devices or AI chips under that host device for performing future AI recognition tasks. In some examples, the global optimal AI model may be shared among multiple processing devices on the network, in which any device may load the global optimal AI model into an embedded CeNN and execute the CeNN to perform recognition tasks based on the global optimal AI model. If none of the thresholds have been reached, process 200 repeats transmitting the updated initial AI models to the client devices at 204. When the iteration has ended, the global AI model will be the final global AI model. At this time, process 200 has obtained the final AI model for the system.

In determining the global AI model at 209 at each iteration, the process may select the optimal AI model that has the best performance value among all host devices. For example, a host device may determine the optimal AI model for that host device at 207 and make that optimal AI model sharable among other host devices on the network. In a non-limiting example, process 200 may include accessing all other host devices and receiving information about their optimal AI models at 208. Let H_{i,0}, H_{i,1}, . . . , H_{i,K-1} stand for the optimal AI model for host j=0, 1, . . . , K−1, where K is the number of host devices in an outer iteration. Process 200 may determine that global AI model H′_{i,j}=U(H_{i,0}, H_{i,1}, . . . , H_{i,K-1}). In a non-limiting example, function U may include selecting the model with the best performance value. For example, in an outer iteration, a host device may access one or more other host devices and access information about the optimal AI model and associated performance value of those other host devices, and determine the global optimal AI model based on the optimal AI model for the host device itself and the optimal AI models of other host devices. Alternatively and/or additionally, a host device may determine the global optimal AI model based on an average of the optimal AI models among multiple host devices on the network.

In some examples, an AI model may include a 1D column vector, which contains all of the parameters (including weights and other parameters) of the AI model arranged sequentially in 1D. When an AI model is represented by a 1D column vector, a subtraction of two AI models may include a 1 D column vector containing multiple parameters, each of which is a subtraction of two corresponding parameters in the 1D column vectors that represent the two AI models, respectively. An addition of two AI models may include multiple parameters, each of which is a sum of two corresponding parameters in the two AI models. An average of multiple AI models may include parameters, each of which is an average of the corresponding parameters in the multiple AI models. Similarly, an AI model may be incremented (added or subtracted) by a perturbation. The resulting model may contain multiple parameters, each of which includes a corresponding parameter in the AI model incremented (added or subtracted) by a corresponding parameter in the perturbation. In some examples, an addition of two AI models may be in discrete or finite field. For example, the addition of scalars and biases in two (or multiple) CNN models may be done in a real coordinate space. In another example, the addition of masks in multiple CNN models may be done in finite field, in which each cell in the resulting mask may take the value of −1 or 1.

At each iteration, process 200 may continue receiving information about other host devices at 208 and updating the global AI model at 209 based on the performance values of optimal AI models among multiple host devices. In some examples, process 200 may determine the global AI model at 209 based on the optimal AI models of all of the host devices on the network. In some examples, process 200 may determine the global AI model at 209 based on the optimal AI models of a subset of host devices on the network. For example, the process may only analyze top five optimal AI models from five host devices. Alternatively and/or additionally, the process may remove bottom two host devices in terms of performance values and analyze the optimal AI models of the remaining host devices.

With further reference to FIG. 2, at each iteration, process 200 may further include generating updated initial AI models at 210. This updates the initial AI models for the client device(s) under the host device, thus the training process in each client device may “restart.” In other words, process 200 may find the global AI model at each iteration (e.g., 209) and cause a training process at a client device to update the initial AI model for the client device. For example, at the dth iteration, and for client device i, where i=0, 1, . . . N−1 (N is the number of client devices under the host device), the host device may maintain the current initial AI model at previous iteration M_{i_d-1}, an updated AI model M_{i_op} (referred to as the local optimal AI model of the client device), and the global AI model M_{global} across all host devices. For example, the current AI model M_{i_d-1} and updated AI model M_{i_op} may be obtained from box 206 for a corresponding client device, the global AI model M_{globe} may be obtained from box 209. Process 200 may optimize the training process by adjusting the velocity of AI model.

In some examples, the process may implement box 210 to generate updated initial AI models by determining a velocity of AI model ΔM_{i_d} at the current iteration d based on the velocity of AI model at its previous iteration ΔM_{i_(d-1)}. The new velocity ΔM_{i_d} may also be determined based on the closeness of the current initial AI model for the client device relative to the local optimal AI model for that client device. The new velocity of AI model may also be based on the closeness of the current AI model relative to the global AI model. The closer the current AI model is to the local optimal AI model and/or the global AI model, the lower the velocity of AI model for the next iteration may be. For example, a velocity for client device i at the current dth iteration may be expressed as:

ΔM_{i_d}=w*ΔM_{i_(d-1)}+c1*r1*(M_{i_op}−M_{i_d-1})+c2*r2*(M_{global}-M_{i_d-1})

where w is the inertial coefficient, c1 and c2 are acceleration coefficients, r1 and r2 are random numbers. In some examples, w may be a constant number selected between [0.8, 1.2], c1 and c2 may be constant numbers in the range of [0, 2]. Random numbers r1 and r2 may be generated at each iteration d. The determination of velocity of AI model described herein may allow the training process to have a new model at each iteration moving towards the local optimal AI model (per client device) and the global optimal model of the system.

In some examples, an AI model, such as M_{i_d-1}, may be a column vector, e.g., an n×1 matrix, containing all of the parameters of the AI model arranged sequentially in 1D. A subtraction of two AI models, such as M_{global}−M_{i_d-1} may also be a column vector containing multiple parameters, each of which is a subtraction of two corresponding parameters in M_{global} and M_{i_d-1}. In some examples, r1 and r2 may be diagonal matrices, for example, n×n matrices, for which each parameter in the column vector corresponds to different randomly-generated values r1 and r2. As such, the training process, such as process 200, becomes an n-dimensional optimization problem. As described herein, the velocity of AI model, e.g., ΔM_{i_d}, ΔM_{i_(d-1)}, may contain the same number of parameters as that in an AI model and have the same dimension as the AI model. Once the velocity ΔM_{i_d} is determined, the process may increment the current initial AI model at the previous iteration by the new velocity to determine an updated initial AI model. For example, the updated initial AI model for device i may be determined as M_{i_d}=M_{i_d-1}+ΔM_{i_d}. Process 200 may determine the updated initial models for all of the client devices under the host device in a similar manner. Upon completion of the process at 218, process 200 may further transmit the updated initial AI models to a respective client device.

Now FIG. 3 illustrates a diagram of an example process for obtaining a local AI model that may be implemented in a processing device, such as a client device. A process 300, which may be implemented in a client device, a host device and/or an AI chip, such as shown in FIG. 1, may train an AI model via one or more iterations. In each iteration, process 300 may receive the initial AI model for the client device at 304. For example, at the beginning of the training process, an initial AI model may be defined for some or all of the client devices, and process 300 may receive the initial AI model. Once the training process (e.g., 200 in FIG. 2) has started iterations, process 300 may receive an updated initial AI model, which may be determined by a host device of the client device (e.g., 210 in FIG. 2). Process 300 may also receive one or more test datasets at 302. For example, the dataset may be residing on any of the devices (host or client devices) on the communication network (e.g., 102 in FIG. 1) and may be accessible to any other devices.

Process 300 may also determine an updated AI model at 306 based on the received initial AI model. In some examples, the process may generate an updated model by incurring a perturbation to the initial AI model. For example, at the mth iteration in process 300, an updated AI model for client device i may be represented as M_{i_m}=M_{i_m-1}+ΔM, where ΔM is the perturbation. In some examples, process 300 may include a simulated annealing process in which a small change to the parameters of the AI model is made.

Returning to block 306 in FIG. 3, updating the AI model may include updating one or more parameters of the AI model with a probability to change and an amplitude of change for a group of parameters. For example, the probabilities to change the scalar, the mask and the bias may each be 0.01, 0.001, and 0.01, respectively. The amplitude of change for scalar and bias may be 0.001. In an example implementation, the process may generate a random number, e.g, in the range of 0 and 1.0, and compare the random number to the probabilities for the group of parameters. If the random number exceeds the probability for a given group of parameters, that group of parameters may change according to the amplitude of change. In case of the previous example, a random number may be generated. If the random number is greater than 0.01, the process may subsequently change the scalar by 0.001. In changing the values in a mask, the process may change each value in the mask to its neighboring value. For example, if a value in a mask is a binary having two values (+1, −1), each change of value may become a switching between the two values (−1 or +1).

With further reference to FIG. 3, process 300 may further include inferring the performance of the updated AI model by running the AI chip in the client device to perform an AI task and obtain AI performance values based on the updated AI model at 308 and determining the performance value of the updated AI model at 310. In some examples, running the AI chip in the client device may include causing a processing device in the client device to execute a recognition task in the AI chip where an embedded CeNN of the AI chip contains the updated AI model, such as a CNN. In other words, if the AI chip is a hardware-based chip, the parameters of the updated AI model are loaded into the CeNN of the AI chip for performing the AI task. An AI task, such as a recognition task may depend on the dataset. For example, a dataset may include sample training images of scenes for a scene recognition task. For a recognition task using the dataset, a performance value may be measured against the AI model being used. For example, an accuracy value may be determined at 310 based on the result of a given recognition task using the updated AI model.

In some examples, process 300 maintains the current AI model and associated performance value at each iteration. A client device may also receive from its host device or have access to the optimal AI model of the host device among all client devices on the host and/or the associated performance value of the optimal AI model. An example of obtaining an optimal AI model of a host device is shown in 207 in FIG. 2. Upon determining the performance value of the updated AI model, process 300 may further determine whether to replace the current AI model with the updated AI model so that the process is able to maintain the optimal AI model at any time. In some examples, process 300 may determine to replace the current AI model with the updated AI model with a probability, which indicates a probability that the current AI model in the client device be replaced by the updated AI model. This probability may be determined based on the performance value of the updated AI model relative to the past performance value in the previous iteration. For example, a probability (for replacing the current AI model) may have a value of one (100%) if the updated AI model has a performance value that is better than the performance value of the optimal AI model of the host on which the current client device is residing.

Alternatively, and/or additionally, if the updated AI model has a performance value that is no better than the performance value of the optimal AI mode of the host, process 300 may still have a probability to replace the current AI model with the updated AI model. This may prevent the process from being “locked” into a local optimal point permanently so that the process can get on a healthy convergence curve to achieve a global optimal AI model. In an example implementation, the process may generate a random number, e.g., in the range of 0 and 1.0, and compare the random number to the probabilities for replacing the current AI model. If the random number exceeds the probability, that process may determine that the current AI model be replaced by the updated AI model. Otherwise, the process may continue without replacing the current AI model with the updated AI model.

In a non-limiting example, the probability for replacing the current AI model may decrease as the performance value of the updated AI model gets closer to the optimal AI model of the host device this is because, once the performance value of the AI model in the training is approaching an optimal value, the process may tend to converge and the probability of replacing the optimal AI model may diminish. Similarly, if the training process is on a healthy curve, it means that the training process should converge as time passes by. As such, the probability of replacing the optimal AI model should decrease as the number of iterations increases. In a non-limiting example, the probability may be determined as:

p=e^{-(Aop-Am)*m}/C

where Aₒₚ is the performance value of the optimal AI model of the host that hosts the client device, Aₘ is the performance value of the current AI model in the client device, m is the number of iterations, and C is a constant factor. For example, C may be selected as 0.001. Other variations of determining the probability may also be possible.

With further reference to FIG. 3, if it is determined that the current AI model be replaced by the updated AI model, process 300 may proceed with replacing the current AI model with the updated AI model at 314 and repeat the iteration at 304. If it is determined that the current AI model not be replaced by the updated AI model, the process may repeat the iteration at 304, provided that the number of iterations has not exceeded a threshold T at 316. If the number of iterations has exceeded the threshold T, the process may stop the iteration and transmit the current AI model to the host device at 318. Additionally, and/or alternatively, the process may also transmit the performance value of the current AI model to the host device at 318. At this point, the current AI model may be noted as a local optimal AI model of the client device. In a host device, a training process (e.g., process 200 in FIG. 2) may receive the updated AI models (or local optimal AI models) from the client devices under that host device (e.g., 206 in FIG. 2) and continue executing one or more steps in that training process to obtain the global AI model as depicted in FIG. 2.

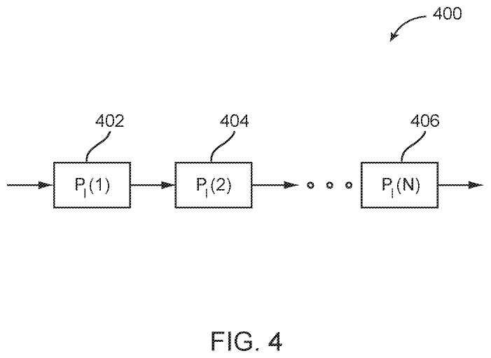

It is appreciated that the disclosures of various embodiments in FIGS. 1-3 may vary. For example, the number of iterations in process 200 in FIG. 2 and the number of iterations in process 300 in FIG. 3 may be independent. In a non-limiting example, the number of iterations for a client device may be in the range of 10-100, and the number of iterations for a host device may be 100. Other values may also be possible. In some scenarios, depending on how the AI model is updated in each client device (such as described in FIG. 3), the process 200 may vary as further described with reference to FIGS. 4-6.

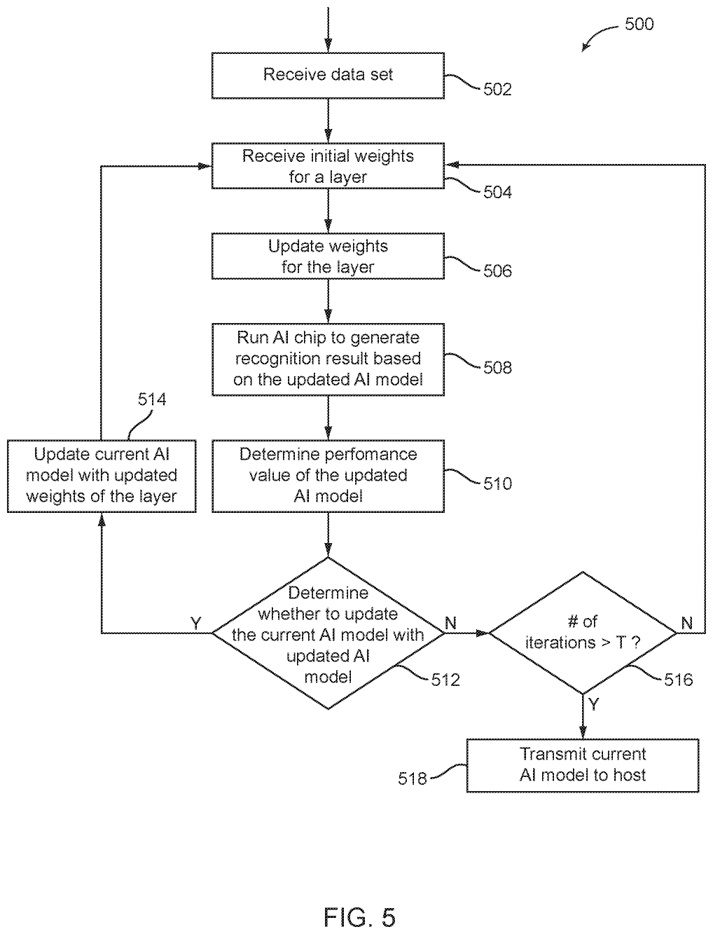

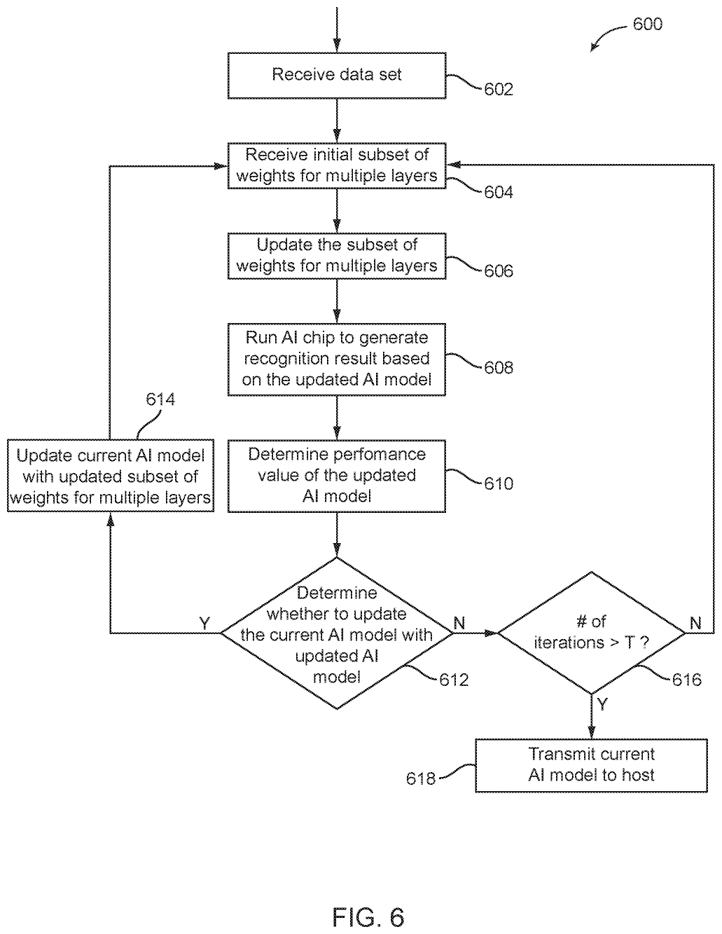

FIG. 4 depicts a variation of the process 200 in FIG. 2 in obtaining an optimal AI model by searching multiple subsets of parameters of an AI model iteratively. In some examples, the boxes 204, 206, 207, 208, 209 and 210 are collectively represented as P_{I}, indicating the Ith iteration process in FIG. 200 (represented by iteration count). In FIG. 4, process 400 may include repeating the process P_{I} multiple times, such as P_{I}(1), P_{I}(2), . . . P_{I}(N), each of the P_{I}'s representing a collective process, such as boxes 204, 206, 207, 208, 209 and 210 in FIG. 2. In some examples, a P_{I} process, such as P_{I}(1), may include working with an updated AI model received from a client device (e.g., 206 in FIG. 2), where the AI model is updated by a subset of the AI model in each iteration. When the iterations are complete, all of the subsets of the AI model will have been searched. In some examples, the subsets of the AI model may be arranged in a layer by layer manner, in which each subset includes the parameters of a convolution layer of the AI model (e.g., a CNN model). In some examples, the subsets of the AI model may be arranged by the type of parameters. For example, one subset of parameters of an AI model may include the masks across all of the convolution layers of the AI model, and another subset may include the scalars across all convolution layers in the AI model. In some examples, the subsets of the AI model may be arranged in a combination of layers and types of parameters of the AI model. This is further illustrated in FIGS. 5-6.

Now FIG. 5 illustrates a diagram of an example process for obtaining a local AI model that may be implemented in a processing device, such as a client device. In some examples, an AI model may have multiple subsets of parameters (including weights). In training an AI model, a subset of the multiple subsets of parameters of the AI model are trained each time, instead of the entire multiple subsets, to reduce the search space of the training. This may achieve higher efficiency than updating the entire AI model. In some examples, the process 500 may update the AI model by one of the multiple subsets of weights. For example, a CNN model may include multiple convolution layers, e.g., 16, 32 or other number of layers, each layer in the CNN model may include multiple weights, bias and other parameters. A subset of the AI model parameters may include multiple weights and/or parameters in a convolution layer. For example, a convolution layer may include a kernel (e.g., 3×3), a scalar and a bias, as described previously in the current disclosure. A subset of the AI model parameters may also include all of the kernels across all of the layers, or all of the scalars across all of the layers, or all of the biases across the layers.

By way of example, FIG. 5 illustrates a process of updating an AI model in a layer by layer fashion. For example, a process 500, which may be implemented in a client device, a host device and/or an AI chip, such as shown in FIG. 1, may train an AI model via one or more iterations. Once the training process (e.g., 200 in FIG. 2) has started iterations, process 500 may receive an updated initial AI model for the client device at 504. In some examples, the updated initial AI model may be determined by a host device of the client device (e.g., 210 in FIG. 2, or one of the processes P_{I}(1) . . . P_{I}(N) in FIG. 4). For example, the host device may implement one or more boxes in FIG. 2 to generate updated initial AI models by determining a velocity of AI model ΔM_{i_d} at the current iteration d based on the velocity of AI model at its previous iteration ΔM_{i_(d-1)}. The new velocity ΔM_{i_d} may also be determined based on the closeness of the current initial AI model for the client device relative to the local optimal AI model for that client device. The new velocity of AI model may also be based on the closeness of the current AI model relative to the global AI model. Detailed description with respect to the determination of velocity are also applicable to the process 500.

Process 500 may also receive one or more test datasets at 502. In some examples, the dataset may be residing on any of the devices (host or client devices) on the communication network (e.g., 102 in FIG. 1) and may be accessible to any other devices.

In each subsequent iteration in FIG. 5, the process 500 may update the initial AI model by one subset of the multiple subsets of parameters (including weights) at 506 while leaving other parameters unchanged. For example, box 504 may receive initial weights of the AI model for a given convolution layer, e.g., the first layer, and box 506 may update the weights of that first layer only based on the received initial AI model, and determine an updated AI model at 506 based on the updated weights in the first layer of the AI model. In some examples, the process may generate an updated model by incurring a perturbation to the initial AI model. For example, at mth iteration in process 500, an updated AI model for client device i may be represented as M_{i_m}=M_{i_m-1}+ΔM, where ΔM is the perturbation. In some examples, process 500 may include a simulated annealing process in which a small change to the parameters of the AI model are made. For example, an AI model may include three groups of parameters: the scalar, the mask (kernel), and the bias.

Returning to block 506 in FIG. 5, updating the AI model may include updating one or more weights or other parameters of the AI model in a given layer with a probability to change and an amplitude of change for a group of parameters. For example, the probabilities to change the scalar, the mask and the bias may each be 0.01, 0.001, and 0.01, respectively. The amplitude of change for scalar and bias may be 0.001. In an example implementation, the process may generate a random number, e.g., in the range of 0 and 1.0, and compare the random number to the probabilities for the group of parameters. If the random number exceeds the probability for a given group of parameters, that group of parameters may change according to the amplitude of change. In case of the previous example, a random number may be generated. If the random number is greater than 0.01, the process may subsequently change the scalar by 0.001. In changing the values in a mask, the process may change each value in the mask to its neighboring value. For example, if a value in a mask is a binary having two values {+1, −1}, each change of value may become a switching between the two values (−1 or +1).

With further reference to FIG. 5, process 500 may further include inferring the performance of the updated AI model by running the AI chip in the client device based on the updated AI model at 508 and determining the performance value of the updated AI model at 510. When running the AI chip based on the updated AI model, the process may perform an AI task to obtain the performance value of the updated AI model. In some examples, running the AI chip in the client device may include causing a processing device in the client device to execute a recognition task in the AI chip where an embedded CeNN of the AI chip contains the updated AI model, such as a CNN. In other words, if the AI chip is a hardware-based chip, the parameters (including weights) of the updated AI model are loaded into the CeNN of the AI chip for performing the AI tasks. An AI task, such as a recognition task may depend on the dataset. For example, a dataset may include sample training images of scenes for a scene recognition task. For a recognition task using the dataset, a performance value may be measured against the AI model being used. For example, an accuracy value may be determined at 510 based on the result of a given recognition task using the updated AI model.

In some examples, process 500 maintains the current AI model and associated performance value at each iteration. A client device may also receive from its host device or have access to the optimal AI model of the host device among all client devices on the host and/or the associated performance value of the optimal AI model. An example process of obtaining an optimal AI model of a host device is shown in 207 in FIG. 2. Upon determining the performance value of the updated AI model, process 500 may further determine whether to replace the current AI model with the updated AI model so that the process is able to maintain the optimal AI model at any time. In some examples, process 500 may determine to replace the current AI model with the updated AI model with a probability, which indicates a probability that the current AI model in the client device be replaced by the updated AI model. This probability may be determined based on the performance value of the updated AI model relative to the past performance value in the previous iteration. For example, a probability (for replacing the current AI model) may have a value of one (100%) if the updated AI model has a performance value that is better than the performance value of the optimal AI model of the host on which the current client device is residing.

Alternatively, and/or additionally, if the updated AI model has a performance value that is no better than the performance value of the optimal AI mode of the host, process 500 may still have a probability to replace the current AI model with the updated AI model. This may prevent the process from being “locked” into a local optimal point permanently so that the process can get on a healthy convergence curve to achieve a global optimal AI model. In an example implementation, the process may generate a random number, e.g., in the range of 0 and 1.0, and compare the random number to the probabilities for replacing the current AI model. If the random number exceeds the probability, that process may determine that the current AI model be replaced by the updated AI model. Otherwise, the process may continue without replacing the current AI model with the updated AI model.

In a non-limiting example, the probability for replacing the current AI model may decrease as the performance value of the updated AI model gets closer to the optimal AI model of the host device this is because, once the performance value of the AI model in the training is approaching an optimal value, the process may tend to converge and the probability of replacing the optimal AI model may diminish. Similarly, if the training process is on a healthy curve, it means that the training process should converge as time passes by. As such, the probability of replacing the optimal AI model should decrease as the number of iterations increases. In a non-limiting example, the probability may be determined as:

p=e^{-(Aop-Am)*m}/C

where Aₒₚ is the performance value of the optimal AI model of the host that hosts the client device, Aₘ is the performance value of the current AI model in the client device, m is the number of iterations, and C is a constant factor. For example, C may be selected as 0.001. Other variations of determining the probability may also be possible.

With further reference to FIG. 5, if it is determined that the current AI model be replaced by the updated AI model, process 500 may proceed with updating the current AI model with the updated subset of parameters for the given layer of the AI model at 514 and repeats the iteration at 504. If it is determined that the current AI model not be replaced by the updated AI model, the process may repeat the iteration at 504, provided that the number of iterations has not exceeded a threshold Tat 516. If the number of iterations has exceeded the threshold T, the process may stop the iteration and transmit the current AI model to the host device at 518. Additionally, and/or alternatively, the process may also transmit the performance value of the current AI model to the host device at 518. In the example in FIG. 5, in each iteration, the process updates the AI model by the subset of parameters for the same given layer, leaving the weights of other layers unchanged. At this point, the current AI model may be noted as a local optimal AI model of the client device. In a host device, a training process (e.g., process 200 in FIG. 2) may receive the updated AI models (or local optimal AI models) from the client devices under that host device (e.g., 206 in FIG. 2) and continue executing one or more steps in that training process to obtain the global AI model as depicted in FIG. 2.

While the subset of parameters for a given layer of the AI model are trained via multiple iterations in process 500, other layers may be trained by one of the processes P_{I}(1) . . . P_{I}(N) in FIG. 4. For Example, in FIG. 4, process P_{I}(1) may include training for the first layer of the AI model, process P_{I}(2) may include training for the second layer, or in a different order. In other words, if an AI model includes a CNN model that has 16 layers, then process 400 may include repeating the process P_{I}(in FIG. 2) for 16 times, each corresponding to a subset of the AI model, in this case, a convolution layer of the CNN model. In some scenarios, other ways of dividing an AI model by multiple subsets of parameters are also possible. For example, a CNN model may include kernels, scalars and bias across multiple layers. A first subset of the AI model may include kernels across the multiple layers, a second subset may include scalars across the multiple layers, and a third subset may include the bias values across the multiple layers. In such case, the process 400 in FIG. 4 may include three blocks P_{I}(1), P_{I}(2), P_{I}(3), which may be configured to train the corresponding subset of the first, second and third subsets of the AI model. This is further described in FIG. 6.

Now FIG. 6 illustrates a diagram of an example process for obtaining a local AI model that may be implemented in a processing device, such as a client device. By way of example, FIG. 6 illustrates a process of updating an AI model by a subset of parameters of the AI model. For example, a process 600, which may be implemented in a client device, a host device and/or an AI chip, such as shown in FIG. 1, may train an AI model via one or more iterations. Once the training process (e.g., 200 in FIG. 2) has started iterations, process 600 may receive an updated initial AI model for the client device at 604. The updated initial AI model may be determined by a host device of the client device (e.g., 210 in FIG. 2, or one of the processes P_{I}(1) . . . P_{I}(N) in FIG. 4). For example, the host device may implement one or more boxes in FIG. 2 to generate updated initial AI models by determining a velocity of AI model ΔM_{i_d} at the current iteration d based on the velocity of AI model at its previous iteration ΔM_{i_(d-1)}. The new velocity ΔM_{i_d} may also be determined based on the closeness of the current initial AI model for the client device relative to the local optimal AI model for that client device. The new velocity of AI model may also be based on the closeness of the current AI model relative to the global AI model. Detailed description with respect to the determination of velocity are also applicable to the process 600. Process 600 may also receive one or more test datasets at 602. For example, the dataset may be residing on any of the devices (host or client devices) on the communication network (e.g., 102 in FIG. 1) and may be accessible to any other devices.

In each subsequent iteration in FIG. 6, the process 600 may update the initial AI model by a subset of parameters (including weights) at 606 while leaving other parameters unchanged. For example, box 604 may receive initial weights of a subset of weights of an AI model. In some scenarios, a subset of parameters of an AI model may be obtained by the type of parameters. For example, a first subset may include the kernels across multiple or all convolutions layers of the CNN model. In such case, the process 600 trains the kernels only for the AI model and transmit an updated AI model by the changes of kernels at 618. In some scenarios, a second subset may include the scalars across one or more layers of the AI model. In such case, the process 600 trains the scalars only for the AI model and transmit an updated AI model by the changes of scalars at 618. In some scenarios, a third subset may include the bias values across one or more layers of the AI model. In such case, the process 600 trains the bias values only for the AI model and transmit an updated AI model by the changes of bias values at 618.

In some example, the process 200 in FIG. 2 may implement the training of the AI model by repeating the process P_{I} in the manner described in FIG. 4. The process P_{I}, may be repeated three times P_{I}(1) . . . P_{I}(3), where each of the processes P_{I}(1), P_{I}(2) and P_{I}(3) may train the respective first, second and third subsets of the AI model, such as the kernels, the scalars and the bias values. The order of the parameters of the AI model in the training, e.g., the kernels, the scalars and the bias values, may not matter. For example, P_{I}(1) . . . P_{I}(3) may respectively train the kernels, the scalars and the bias values across multiple convolution layers in the AI model. Alternatively, P_{I}(1) . . . P_{I}(3) may respectively train the bias values, the kernels and the scalars across multiple convolution layers in the AI model. Alternatively, and/or additionally, the process may train a subset of parameters in a convolution layer followed by another subset of parameters in the same convolution layer before searching in other convolution layers. For example, P_{I}(1) may train a first subset of weights in the first convolution layer, P_{I}(2) may train a second subset of weights in the same convolution layer, and P_{I}(3) may train a subset of weights in the second convolution layer, and so on.

Without limiting the scope of the disclosure, take the first subset of the AI model, for example, a training process for training the kernels is described in detail. The training of other subsets, such as scalars or bias values, may be implemented in the process 600 in a similar manner. In some examples, process 600 may include updating the kernels of the AI model based on the received initial AI model, and determine an updated AI model at 606 based on the updated kernels of the AI model. In some examples, the process may generate an updated model by incurring a perturbation to the initial AI model. For example, at mth iteration in process 600, an updated AI model for client device i may be represented as M_{i_m}=M_{i_m-1}+ΔM, where ΔM is the perturbation. In some examples, process 600 may include a simulated annealing process in which a small change to one of multiple subsets of weights of the AI model are made.

Returning to block 606 in FIG. 6, updating the AI model may include updating one or more kernels of the AI model across multiple layers or all layers with a probability to change and an amplitude of change. For example, the probability to change the kernels may be 0.001. If process 600 is implemented to update the AI model based on scalars, the probability to change the scalars may be 0.01. In some examples, if process 600 is implemented to update the AI model based on biases, the probability to change the bias may 0.01. In changing the values in a mask, the process may change each value in the mask to its neighboring value. For example, if a value in a mask is a binary having two values {+1, −1}, each change of value may become a switching between the two values (−1 or +1). In some examples, the amplitude of change for scalar and bias may be 0.001. In an example implementation, the process may generate a random number, e.g., in the range of 0 and 1.0, and compare the random number to the probabilities for the group of parameters. If the random number exceeds the probability for a given group of parameters, that group of parameters may change according to the amplitude of change. In case of the previous example, a random number may be generated. If the random number is greater than 0.01, the process may subsequently change the scalar by 0.001.

With further reference to FIG. 6, process 600 may further include inferring the performance of the updated AI model by running the AI chip in the client device to obtain AI task performance at 608. For example, the process 600 may generate a voice recognition result based on the updated AI model at 608 and determine the performance value of the updated AI model at 610. In some examples, running the AI chip in the client device may include causing a processing device in the client device to perform an AI task in the AI chip where an embedded CeNN of the AI chip contains the updated AI model, such as a CNN. In other words, if the AI chip is a hardware-based chip, the parameters of the updated AI model are loaded into the CeNN of the AI chip for performing the AI tasks. An AI task may depend on the dataset. For example, a dataset may include sample training images of scenes for a scene recognition task. For a recognition task using the dataset, a performance value may be measured against the AI model being used. For example, an accuracy value may be determined at 610 based on the result of a given recognition task using the updated AI model.

In some examples, process 600 maintains the current AI model and associated performance value at each iteration. A client device may also receive from its host device or have access to the optimal AI model of the host device among all client devices on the host and/or the associated performance value of the optimal AI model. An example of obtaining an optimal AI model of a host device is shown in 207 in FIG. 2. Upon determining the performance value of the updated AI model, process 600 may further determine whether to replace the current AI model with the updated AI model so that the process is able to maintain the optimal AI model at any time. In some examples, process 600 may determine to replace the current AI model with the updated AI model with a probability, which indicates a probability that the current AI model in the client device be replaced by the updated AI model. This probability may be determined based on the performance value of the updated AI model relative to the past performance value in the previous iteration. For example, a probability (for replacing the current AI model) may have a value of one (100%) if the updated AI model has a performance value that is better than the performance value of the optimal AI model of the host on which the current client device is residing.

Alternatively, and/or additionally, if the updated AI model has a performance value that is no better than the performance value of the optimal AI mode of the host, process 600 may still have a probability to replace the current AI model with the updated AI model. This may prevent the process from being “locked” into a local optimal point permanently so that the process can get on a healthy convergence curve to achieve a global optimal AI model. In an example implementation, the process may generate a random number, e.g., in the range of 0 and 1.0, and compare the random number to the probabilities for replacing the current AI model. If the random number exceeds the probability, that process may determine that the current AI model be replaced by the updated AI model. Otherwise, the process may continue without replacing the current AI model with the updated AI model.

In a non-limiting example, the probability for replacing the current AI model may decrease as the performance value of the updated AI model gets closer to the optimal AI model of the host device this is because, once the performance value of the AI model in the training is approaching an optimal value, the process may tend to converge and the probability of replacing the optimal AI model may diminish. Similarly, if the training process is on a healthy curve, it means that the training process should converge as time passes by. As such, the probability of replacing the optimal AI model should decrease as the number of iterations increases. In a non-limiting example, the probability may be determined as:

p=e^{-(Aop-Am)*m}/C

where Aₒₚ is the performance value of the optimal AI model of the host that hosts the client device, Aₘ is the performance value of the current AI model in the client device, m is the number of iterations, and C is a constant factor. For example, C may be selected as 0.001. Other variations of determining the probability may also be possible.

With further reference to FIG. 6, if it is determined that the current AI model be replaced by the updated AI model, process 600 may proceed with updating the current AI model with the updated subset of parameters, for example, the weights (e.g., the kernels or the scalars) or the bias values for all of the layers of the CNN model at 614, and repeats the iteration at 604. If it is determined that the current AI model not be replaced by the updated AI model, the process may repeat the iteration at 604, provided that the number of iterations has not exceeded a threshold T at 616. If the number of iterations has exceeded the threshold T, the process may stop the iteration and transmit the current AI model to the host device at 618. Additionally, and/or alternatively, the process may also transmit the performance value of the current AI model to the host device at 618. In the example in FIG. 6, in each iteration, the process updates the AI model by the same subset of parameters for one or more layers, for example, scalars for all of the convolution layers of a CNN model, leaving the parameters of other subsets unchanged. At this point, the current AI model may be noted as a local optimal AI model of the client device. In a host device, a training process (e.g., process 200 in FIG. 2) may receive the updated AI models (or local optimal AI models) from the client devices under that host device (e.g., 206 in FIG. 2) and continue executing one or more steps in that training process to obtain the global AI model as depicted in FIG. 2.

While the subset of kernels across one or more layers of the AI model are trained via multiple iterations in process 600, other subsets may be trained by one of the processes P_{I}(1) . . . P_{I}(N) in FIG. 4. For Example, in FIG. 4, process P_{I}(1) may include training for the kernels of all convolution layers of an CNN model, process P_{I}(2) may include training the scalars of all convolution layers of the CNN model, and process P_{I}(3) may include training the biases of all convolution layers of the CNN model. The order of P_{I}(1), P_{I}(2) and P_{I}(3) may be different. Although the examples in FIG. 6 facilitates three repeating processes in FIG. 4, other number of repeated processes may be possible. For example, a CNN model may be divided by four (or other numbers) subsets, each containing a portion of parameters across all convolutions layers of the CNN model. In such case, FIG. 4 may include four repeating processes P_{I}, each implementing an instance of process 600 based on updating a corresponding one of the four subsets of parameters.

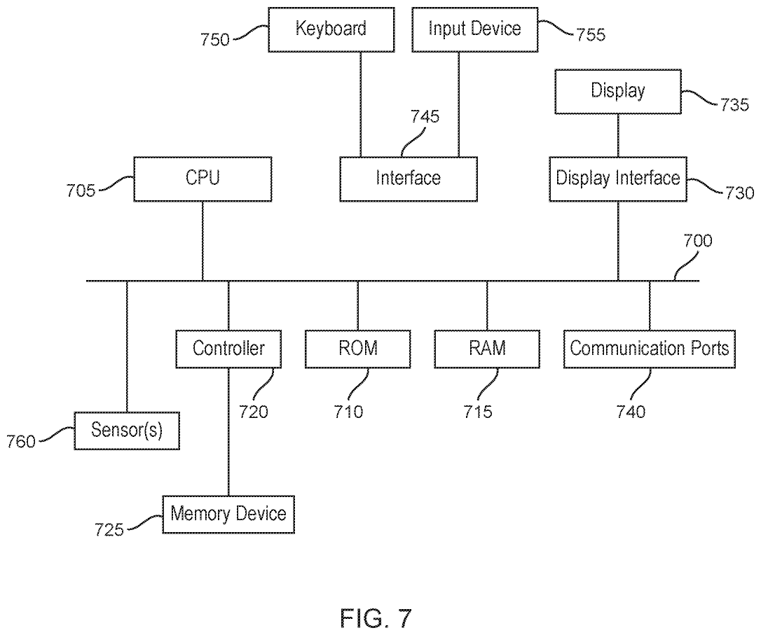

FIG. 7 depicts an example of internal hardware that may be included in any electronic device or computing system for implementing various methods in the embodiments described in FIGS. 1-6. An electrical bus 700 serves as an information highway interconnecting the other illustrated components of the hardware. Processor 705 is a central processing device of the system, configured to perform calculations and logic operations required to execute programming instructions. As used in this document and in the claims, the terms “processor” and “processing device” may refer to a single processor or any number of processors in a set of processors that collectively perform a process, whether a central processing unit (CPU) or a graphics processing unit (GPU) or a combination of the two. Read only memory (ROM), random access memory (RAM), flash memory, hard drives, and other devices capable of storing electronic data constitute examples of memory devices 725. A memory device, also referred to as a computer-readable medium, may include a single device or a collection of devices across which data and/or instructions are stored.

An optional display interface 730 may permit information from the bus 700 to be displayed on a display device 735 in visual, graphic, or alphanumeric format. An audio interface and audio output (such as a speaker) also may be provided. Communication with external devices may occur using various communication ports 740 such as a transmitter and/or receiver, antenna, an RFID tag and/or short-range, or near-field communication circuitry. A communication port 740 may be attached to a communications network, such as the Internet, a local area network, or a cellular telephone data network.

The hardware may also include a user interface sensor 745 that allows for receipt of data from input devices 750 such as a keyboard, a mouse, a joystick, a touchscreen, a remote control, a pointing device, a video input device, and/or an audio input device, such as a microphone. Digital image frames may also be received from an imaging capturing device 755 such as a video or camera that can either be built-in or external to the system. Other environmental sensors 760, such as a GPS system and/or a temperature sensor, may be installed on system and communicatively accessible by the processor 705, either directly or via the communication ports 740. The communication ports 740 may also communicate with the AI chip to upload or retrieve data to/from the chip. For example, the global optimal AI model may be shared by all of the processing devices on the network. Any device on the network may receive the global AI model from the network and upload the global AI model, e.g., CNN parameters, to the AI chip via the communication port 740 and an SDK (software development kit). The communication port 740 may also communicate with any other interface circuit or device that is designed for communicating with an integrated circuit.

Optionally, the hardware may not need to include a memory, but instead programming instructions are run on one or more virtual machines or one or more containers on a cloud. For example, the various methods illustrated above may be implemented by a server on a cloud that includes multiple virtual machines, each virtual machine having an operating system, a virtual disk, virtual network and applications, and the programming instructions for implementing various functions in the robotic system may be stored on one or more of those virtual machines on the cloud.

Various embodiments described above may be implemented and adapted to various applications. For example, the AI chip having a CeNN architecture may be residing in an electronic mobile device. The electronic mobile device may use the built-in AI chip to perform AI tasks. For example, the electronic mobile device may produce recognition results and generate performance values. In some scenarios, obtaining the CNN can be done in the mobile device itself, where the mobile device retrieves test data from a dataset and uses the built-in AI chip to perform the training. In other scenarios, the processing device may be a server device in the communication network (e.g., 102 in FIG. 1) or may be on the cloud. These are only examples of applications in which an AI task can be performed in the AI chip.

The various systems and methods disclosed in this patent document provide advantages over the prior art, whether implemented standalone or combined. For example, using the systems and methods described in FIGS. 1-6 may help obtain the global optimal AI model using multiple networked devices in either centralized or decentralized or distributed network. This networked approach helps the system to narrow the search space of the AI model during the training process thus the system may converge to the global optimal AI model faster. For example, when training an AI model by a subset of parameters (e.g., by layers or types of parameters) in each iteration, the training process will converge to the global optimal AI model faster and also consume less memory, which will result in less computing time.

The above disclosed embodiments also allow different training methods to be adapted to obtain the global optimal AI model, whether test data dependent or test data independent. For example, a client device may implement its own training process to obtain the local optimal AI model. Above illustrated embodiments are described in the context of generating a CNN model for an AI chip (physical or virtual), but can also be applied to various other applications. For example, the current solution is not limited to implementing the CNN but can also be applied to other algorithms or architectures inside an AI chip.

It will be readily understood that the components of the present solution as generally described herein and illustrated in the appended figures could be arranged and designed in a wide variety of different configurations. Thus, the following more detailed description of various implementations, as represented in the figures, is not intended to limit the scope of the present disclosure, but is merely representative of various implementations. While the various aspects of the present solution are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages, and characteristics of the present solution may be combined in any suitable manner in one or more embodiments. One ordinarily skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Other advantages can be apparent to those skilled in the art from the foregoing specification. Accordingly, it will be recognized by those skilled in the art that changes, modifications, or combinations may be made to the above-described embodiments without departing from the broad inventive concepts of the invention. It should therefore be understood that the present solution is not limited to the particular embodiments described herein, but is intended to include all changes, modifications, and all combinations of various embodiments that are within the scope and spirit of the invention as defined in the claims.

We claim:

1. A system comprising:
a plurality of artificial intelligence (AI) chips; and
a processing device communicatively coupled to the plurality of AI chips and configured to:
(i) transmit a respective initial AI model to each of the plurality of AI chips;
(ii) receive a respective AI model and an associated performance value of the respective AI model from each of the plurality of AI chips, wherein the respective AI model is updated based on the respective initial AI model by one of a plurality of subsets of parameters of the respective initial AI model;
(iii) determine an optimal AI model that has a best performance value among the performance values associated with the respective AI models from the plurality of AI chips; and
(iv) determine a global AI model based on the optimal AI model.

2. The system of claim 1, wherein the processing device is further configured to repeat steps (i)-(iv) for multiple iterations, wherein:
a number of subsets in the plurality of subsets of parameters equals a number of iterations in the multiple iterations; and
in each of the multiple iterations: the respective AI model is updated by a respective subset of parameters based on the respective initial AI model.

3. The system of claim 2, wherein a subset of the plurality of subsets of parameters of the respective initial AI model include weights of a respective convolution layer of a CNN model.

4. The system of claim 2, wherein a subset of the plurality of subsets of parameters of the respective initial AI model include a respective group of parameters of a CNN model selected from one of: kernels, scalars, and bias values of one or more convolution layers of the CNN model.

5. The system of claim 2, wherein the processing device is further configured to, at each of the multiple iterations, generate the respective initial AI model for at least one of the plurality of AI chips based on a respective previous initial AI model for that AI chip that is generated at a preceding iteration and a velocity of AI model for that AI chip.

6. The system of claim 5, wherein the velocity of AI model for the AI chip is based on at least one of (1) a closeness of the respective previous initial AI model relative to the optimal AI model; and (2) a closeness of the respective previous initial AI model relative to the global AI model.

7. The system of claim 2, wherein the processing device is further configured to, upon a completion of the multiple iterations, cause the global AI model to be loaded into a physical AI chip coupled to a sensor, wherein the physical AI chip is configured to:
receive data captured from the sensor; and
perform an AI task based on the captured data and the global AI model in the physical AI chip.

8. A method comprising, at a processing device:
(i) transmit a respective initial AI model to each of a plurality of AI chips;
(ii) receiving a respective AI model and an associated performance value of the respective AI model from each of the plurality of AI chips, wherein the respective AI model is updated based on the respective initial AI model by one of a plurality of subsets of weights of the respective initial AI model;
(iii) determining an optimal AI model that has a best performance value among the performance values associated with the respective AI models from the plurality of AI chips; and
(iv) determining a global AI model based on the optimal AI model.

9. The method of claim 8 further comprising repeating steps (i)-(iv) for multiple iterations, wherein:
a number of subsets in the plurality of subsets of parameters of each of the respective initial AI models equals a number of iterations in the multiple iterations; and
in each of the multiple iterations, the respective AI model is updated by a respective subset of the plurality of subsets of parameters of the respective initial AI model based on the respective initial AI model.

10. The method of claim 9, wherein each subsets of the plurality of subsets of parameters of the respective initial AI model include:
parameters of a respective convolution layer of a CNN model; or
a respective group of parameters of a CNN model selected from one of: kernels, scalars, and bias values of one or more convolution layers of the CNN model.

11. The method of claim 9 further comprising: at each of the multiple iterations, generating the respective initial AI model for at least one of the plurality of AI chips based on a respective previous initial AI model for that AI chip that is generated at a preceding iteration and a velocity of AI model for that AI chip.

12. The method of claim 11, wherein the velocity of AI model for the AI chip is based on at least one of (1) a closeness of the respective previous initial AI model relative to the optimal AI model; and (2) a closeness of the respective previous initial AI model relative to the global AI model.

13. The method of claim 9 further comprising: upon a completion of the multiple iterations, loading the global AI model into a physical AI chip coupled to a sensor to cause the physical AI chip to:
receive data captured from the sensor; and
perform an AI task based on the captured data and the global AI model in the physical AI chip.

14. A device comprising:
an artificial intelligence (AI) chip; and
a processing device containing programming instructions that, when executed, will cause the processing device to:
(i) access a dataset;
(ii) receive an initial artificial intelligence (AI) model from a host device;
(iii) update the initial AI model by updating a subset of parameters of the initial AI model;
(iv) load the initial AI model into the AI chip to determine a first performance value of the initial AI model based on the dataset;
(v) determine a first probability that a current AI model should be replaced by the initial AI model, wherein the current AI model has a second performance value;
(vi) determine, based on the first probability, whether to replace the current AI model with the initial AI model;
(vii) if it is determined that the current AI model be replaced with the initial AI model, replace the current AI model with the initial AI model; and
(viii) transmit the current AI model and the first performance value of the initial AI model to the host device.

15. The device of claim 14 further comprising additional programming instructions configured to cause the processing device to repeat steps (iii-vii) for a number of iterations.

16. The device of claim 14, wherein programming instructions for loading the initial AI model into the AI chip comprise programming instructions to load the subset of parameters of the initial AI model into the AI chip.

17. The device of claim 14, wherein the subset of parameters of the initial AI model include:
weights of a convolution layer of a CNN model; or
a group of parameters of the CNN model selected from one of: kernels, scalars, and bias values of one or more convolution layers of the CNN model.

18. The device of claim 14, wherein programming instructions for updating the initial AI model comprise programming instructions configured to:
determine a second probability of updating the subset of parameters of the initial AI model and an amplitude of change of parameters for the subset of parameters;
determine, based on the second probability, whether to update the subset of parameters of the initial AI model; and
if it is determined that the subset of parameters of the initial AI model be updated, update the subset of parameters of the initial AI model by changing the subset of parameters of the initial AI model by the amplitude of change; otherwise, do not update the subset of parameters of the initial AI model.

19. The device of claim 14, wherein programming instructions for determining the first probability comprise programming instructions configured to determine the first probability based on a closeness of the first performance value of the initial AI model relative to the second performance value of the current AI model.

20. The device of claim 14, wherein programming instructions for determining whether to replace the current AI model with the initial AI model comprise programming instructions configured to:
if the first probability has a value of one, determine that the current AI model be replaced by the initial AI model;
if the first probability has a value of less than one:
generate a random value;
compare the random value to the first probability to determine whether to replace the current AI model with the initial AI model.

21. The device of claim 14, wherein the host device is configured to:
receive the current AI model and the first performance value of the initial AI model from the processing device;
receive trained AI models from additional processing devices;
obtain a global AI model based on the current AI model received from the processing device and the trained AI models from the additional processing devices; and
cause the global AI model to be loaded into a physical AI chip.

22. The device of claim 21, wherein the physical AI chip is coupled to a sensor and configured to:
receive data captured from the sensor; and
perform an AI task based on the captured data and the global AI model in the physical AI chip.
